(19) United States
(12) Patent Application Publication
(10) Pub. No.: US 2015/0105070 A1
(43) Pub. Date: Apr. 16, 2015

(54) Method To Improve Cell Selection Procedures in a Single SIM/Multi-SIM Environment

(71) Applicant: QUALCOMM Incorporated, San Diego, CA (US)

(72) Inventors: Ravi Kanth Kotreka, Hyderabad (IN); Srinivasarao Pasumarthi, Hyderabad (IN); Eswar Kumar Moyya, San Diego, CA (US)

(73) Assignee: QUALCOMM Incorporated, San Diego, CA (US)

(21) Appl. No.: 14/050,800

(22) Filed: Oct. 10, 2013

(51) Int. Cl. H04W 48/00; H04W 60/00

(52) U.S. Cl. CPC H04W 48/17; H04W 60/00
USPC 455/434

(57) ABSTRACT

The various embodiments provide methods implemented by a mobile communication device for determining whether to camp on a cell based on an updated measurement of the received signal strength associated with the cell. A mobile communication device may determine an updated received signal strength for an absolute radio-frequency channel number (“ARFCN”) associated with a cell while or after acquiring and decoding the ARFCN's broadcast control channel. The mobile communication device may utilize the updated signal strength value when calculating the ARFCN's cell's suitability criteria instead of the potentially stale signal strength value acquired during an initial power scan over the frequency band, thereby enabling the mobile communication device to make more accurate cell suitability determinations. Thus, the mobile communication device may experience an increase in performance and/or may increase the user's experience.

### BACKGROUND

In a Global System for Mobile Communications (GSM) system, a mobile communication device (e.g., a cell phone, smartphone, etc.) that has just powered on or has just lost its connection to its mobile network searches for suitable cells from which the mobile communication device can receive communication services by performing a process termed “cell selection.” A “suitable” cell is a cell from which the mobile communication device can receive service, and the GSM standard defines a set of suitability criteria (e.g., acceptable error rate and acceptable signal strength) that a cell must meet in order to be deemed a “suitable cell.”

Currently, as part of the GSM standard, a mobile communication device performing cell selection must camp on the best available cell in the vicinity. To satisfy this requirement, the mobile communication device typically performs an initial power scan over the frequency band to measure the signal strength of the cells in the area and generates a list of cells in decreasing order of the measured received signal strengths for the cells. The mobile communication device then goes through the ordered list of cells, selecting each cell in order to find the first cell in the ordered list that meets the set of suitability criteria. When a suitable cell is found, the mobile communication device performs registration with the cell, if necessary. The mobile communication device then camps on the cell to communicate with a mobile network to which the mobile communication device is subscribed.

### SUMMARY

The various embodiments provide methods implemented by a mobile communication device for determining whether to camp on a cell based on an updated measurement of the received signal strength associated with the cell. In various embodiments, the mobile communication device may determine an updated received signal strength for an absolute radio-frequency channel number (“ARFCN”) associated with a cell while or after acquiring and decoding the ARFCN's broadcast control channel. The mobile communication device may utilize the updated signal strength value when calculating the ARFCN's cell's suitability criteria, which differs from the convention method of calculating the ARFCN's cell's suitability criteria based on the potentially stale signal strength value acquired during an initial power scan over the frequency band. In this manner the various embodiments enable a mobile communication device to make more accurate cell suitability determinations. Thus, the mobile communication device may experience an increase in performance and/or may improve the user's experience by avoiding camping on unsuitable cells and subsequently having to perform a reselection to a better cell.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with the various embodiments.

FIG. 2 is a process flow diagram illustrating a typical method of performing cell selection.

FIG. 3 is a timeline diagram illustrating changes in cells' received signal strength over time as measured by a mobile communication device.

FIG. 4 is a process flow diagram illustrating an embodiment method of performing cell selection with an updated received signal strength value.

FIG. 5 is a block diagram of an example mobile communication device according to an embodiment.

FIG. 6 is a block diagram of another example mobile communication device according to an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “mobile communication device” refers to any one or all of cellular telephones, smart phones, personal or mobile multi-media players, personal data assistants, laptop computers, personal computers, tablet computers, smart books, palm-top computers, wireless electronic mail receivers, multimedia Internet enabled cellular telephones, wireless gaming controllers, and similar personal electronic devices which individually include a programmable processor and memory and circuitry for connecting to at least one mobile communication network. The various embodiments may be useful in mobile communication devices, such as smart phones, and so such devices are referred to in the descriptions of the various embodiments. However, the embodiments may be useful in any electronic devices that may individually maintain one or more subscriptions to one or more mobile networks through one or more radio transceivers.

A mobile communication device may include multiple Subscriber Identity Module (SIM) cards that provide users with access to multiple separate mobile telephony networks. A mobile communication device that includes a plurality of SIMs is herein referred to as a “multi-SIM communication device.” As used herein, the terms “SIM”, “SIM card” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless device on a network. The term SIM may also be used as shorthand reference to a communication network or communication service associated with a particular SIM, since the information stored in a SIM enables the wireless device to establish a communication link with a particular network to receive its services; thus the SIM, the communication network, and the network's services correlate to one another.

Current methods of performing cell selection rely on received signal strengths that a mobile communication device obtains during an initial power scan over the frequency band. However, such methods do not account for the possibility of a substantial change in a received signal strength associated with a cell that may occur between the time when the mobile communication device first calculates the received signal strength during the initial power scan over the frequency band and the time when the mobile communication device uses that received signal strength value to determine the suitability of a cell for connection.

Because current methods do not account for such changes in received signal strengths between when signal strengths are measured and a connection attempt is made, current methods expose the mobile communication device to a risk of using inaccurate, out-of-date or “stale” measurements when determining whether a cell is suitable. When there is a substantial difference between an out-of-date received signal strength value and the cell's actual received signal strength (e.g., when the actual received signal strength value is considerably lower than the out-of-date received signal strength value), the mobile communication device may experience negative effects in some situations. For example, if the mobile communication device camps on a cell based in part on an out-of-date received signal strength value that is significantly higher than the actual received signal strength associated with the cell, the mobile communication device may experience poor call quality and may ultimately require the mobile communication device to perform a handoff or reselection to another, more suitable cell, and thus unnecessarily expend resources to accomplish the hand off, including processing, power, and/or radio resources. This potential problem is increasingly likely as the number of frequencies, bands, and radio access technologies (RAT) continue to increase, because mobile communication devices will need to spend more time between conducting an initial power scan over the frequency band and determining whether a cell is suitable based on received signal strength measurements taken during the initial power scan over the frequency band.

Additionally, stale received signal strength values may have an especially adverse impact on multi-SIM mobile communication devices' performance. Some multi-SIM communication devices that share a radio-frequency (“RF”) resource among two or more subscriptions may require more time between conducting an initial power scan over the frequency band and determining whether a cell is suitable based on measurements taken during the power scan over the frequency band because the multi-SIM mobile communication device must share/multiplex its shared RF resources. This extra time increases the likelihood that a cell's actual received signal strength value differs from the received signal strength value measured during the initial power scan over the frequency band and, therefore, that the received signal strength value used to determine the suitability of the cell is inaccurate. Therefore, users of mobile communication devices (especially multi-SIM mobile communication devices) may benefit from an improved method of cell selection.

In overview, the various embodiments provide methods implemented by a mobile communication device for determining whether to camp on a cell based on an updated measurement of the received signal strength associated with the cell. In various embodiments, the mobile communication device may determine an updated received signal strength for an absolute radio-frequency channel number (“ARFCN”) associated with a cell while or after acquiring and decoding the ARFCN's broadcast control channel (“BCCH”). The mobile communication device may utilize the updated signal strength value when calculating the ARFCN's cell's suitability criteria, which differs from the convention method of calculating the ARFCN's cell's suitability criteria based on the potentially stale signal strength value acquired during an initial power scan over the frequency band. In this manner the various embodiments enable a mobile communication device to make more accurate cell suitability determinations. Thus, the mobile communication device may experience an increase in performance and/or may improve the user's experience by avoiding camping on unsuitable cells and subsequently having to perform a reselection to a better cell.

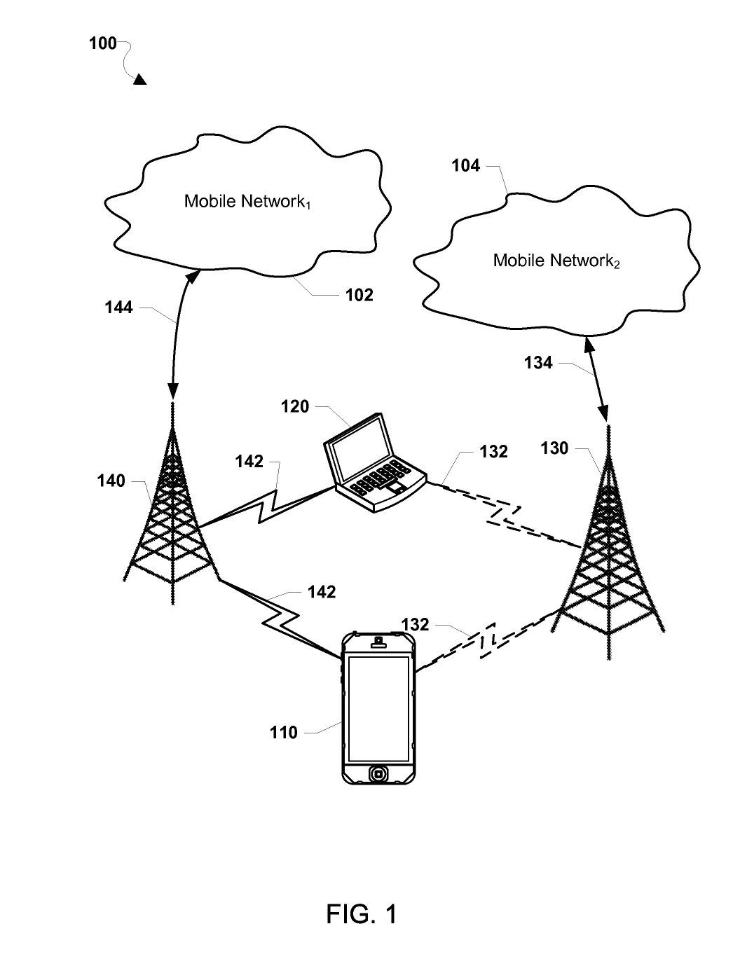

The various embodiments may be implemented within a variety of communication systems 100, such as two or more mobile telephony networks 102, 104, an example of which is illustrated in FIG. 1. Mobile networks 102, 104 typically include a plurality of cellular base stations 130, 140. A first mobile communication device 110 may be in communication with a first mobile network 102 through a cellular connection 142 to a first base station 140, which may be in communication with the first mobile network 102 via a wired connection 144. In an embodiment in which the first mobile communication device 110 is a multi-SIM communication device, the first mobile communication device 110 may be in communication with the second mobile network 104 through an optional cellular connection 132 to a second base station 130, which may be in communication with the second mobile network 104 through a wired connection 134. A second mobile communication device 120 may similarly communicate with the first mobile network 102 through a cellular connection 142 to a first base station 140. The second mobile communication device 120 may also communicate with the second mobile network 104 through an optional cellular connection 132 to the second base station 130 as described above with reference to the first mobile communication device 110. In a further embodiment, the mobile communication devices 110, 120 may optionally connection to an arbitrary number of other mobile networks.

Cellular connections 132, 142 may be made through two-way wireless communication links, such as 4G, 3G, CDMA, TDMA, WCDMA, GSM, and other mobile telephony communication technologies.

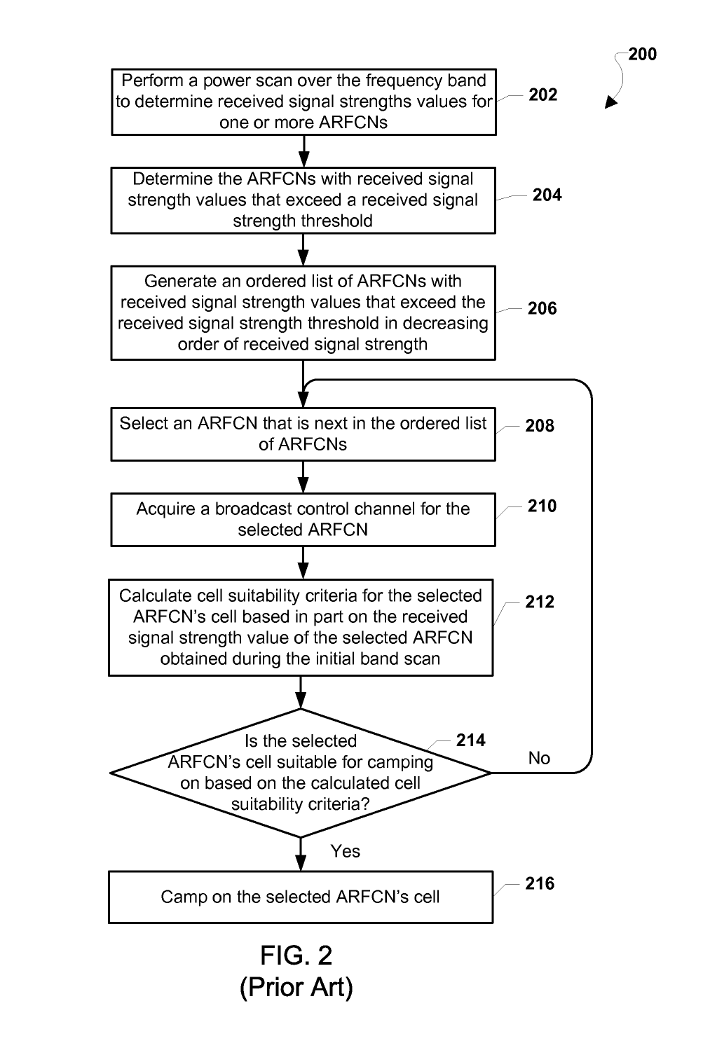

FIG. 2 illustrates a conventional method 200 by which mobile communication devices perform cell selection. In current implementations of cell selection, a mobile communication device attempts to determine the most suitable cell in the immediate area soon after losing service or after powering up.

In block 202, the mobile communication device performs a power scan over the frequency band to determine received signal strength values for one or more ARFCNs. Typically, a mobile communication device performs a power scan over the frequency band by scanning its designated frequency bands, which are divided into a number of RF channels that are each identified by a specific ARFCN associated with a particular cell.

During the power scan over the frequency band, the mobile communication device obtains several received signal strength measurements for each ARFCN. These received signal strength measurements are also referred to as monitors, power measurements, and received signal level measurements. The mobile communication device then computes an average of the several received signal strength measurements obtained for each ARFCN, which is commonly referred to as an “RLA_C” value in GSM.

In block 204, the mobile communication device determines the ARFCNs with received signal strength values that exceed a received signal strength threshold. For example, the mobile communication device may determine that an ARFCN has an RLA_C value that exceeds a minimum receiver power threshold of −90 dB set by a GSM mobile network.

In block 206, the mobile communication device generates an ordered list of ARFCNs with received signal strength values that exceed the received signal strength threshold in decreasing order of received signal strengths. For instance, the mobile communication device may determine that a first and second ARFCN have RLA_C values that exceed a signal strength threshold of −90 dB, and the mobile communication device may rank a first ARFCN higher in the ordered list than a second ARFCN because the first ARFCN has a higher RLA_C value.

In block 208, the mobile communication device selects an ARFCN cell that is next in the ordered list of ARFCNs. After calculating the RLA_C values for one or more ARFCNs and generating the ordered list, the mobile communication device attempts to acquire the ARFCNs in the list, one ARFCN at a time, to find the cell associated with an ARFCN that is the most suitable cell on which to camp. Typically, the mobile communication device selects the strongest ARFCN in the list (i.e., the ARFCN with the largest RLA_C value) first because, in current implementations of cell selection, the first cell in the ordered list determined to be suitable is also assumed to be the most suitable cell because the ARFCNs are sorted in descending order based on their RLA_C values.

In block 210, the mobile communication device acquires a broadcast control channel (“BCCH”) for the selected ARFCN. In current practice, the mobile communication device acquires the BCCH for the selected ARFCN and decodes the BCCH to obtain information used to verify the suitability of the cell associated with the selected ARFCN (i.e., whether the ARFCN's cell meets certain quality of service standards).

In block 212, the mobile communication device calculates cell suitability criteria (e.g., “C1” in a GSM system) for the selected ARFCN's cell based in part on the received signal strength (i.e., RLA_C) value of the selected ARFCN obtained during the initial power scan over the frequency band as described above with reference to block 202. The mobile communication device may also calculate the cell suitability criteria for the selected ARFCN's cell using other information obtained from the ARFCN's BCCH.

In determination block 214, the mobile communication device determines whether the selected ARFCN's cell is suitable for camping on based on the calculated cell suitability criteria. In other word, based on cell suitability criteria—which factors in, among other things, the information included in the BCCH and the RLA_C value of the selected ARFCN determined during the initial power scan over the frequency band—the mobile communication device makes a determination of whether the cell associated with the selected ARFCN is a suitable cell (i.e., whether the mobile communication device should camp on that cell).

When the mobile communication device determines based on the calculated cell suitability criteria that the selected ARFCN's cell is not suitable for camping on (i.e., determination block 214=“No”), the mobile communication device selects another ARFCN that is next in the ordered list of ARFCNs in block 208, and the process is repeated until the mobile communication device selects an ARFCN that is associated with a suitable cell (i.e., determination block 214=“Yes”).

When the mobile communication device determines based on the calculated cell suitability criteria that the selected ARFCN's cell is suitable for camping on (i.e., determination block 214=“Yes”), the mobile communication device camps on the selected ARFCN's cell in block 216. Prior to camping on the selected ARFCN's cell (i.e., the new serving cell), the mobile communication device may perform registration operations with the selected ARFCN's cell when necessary.

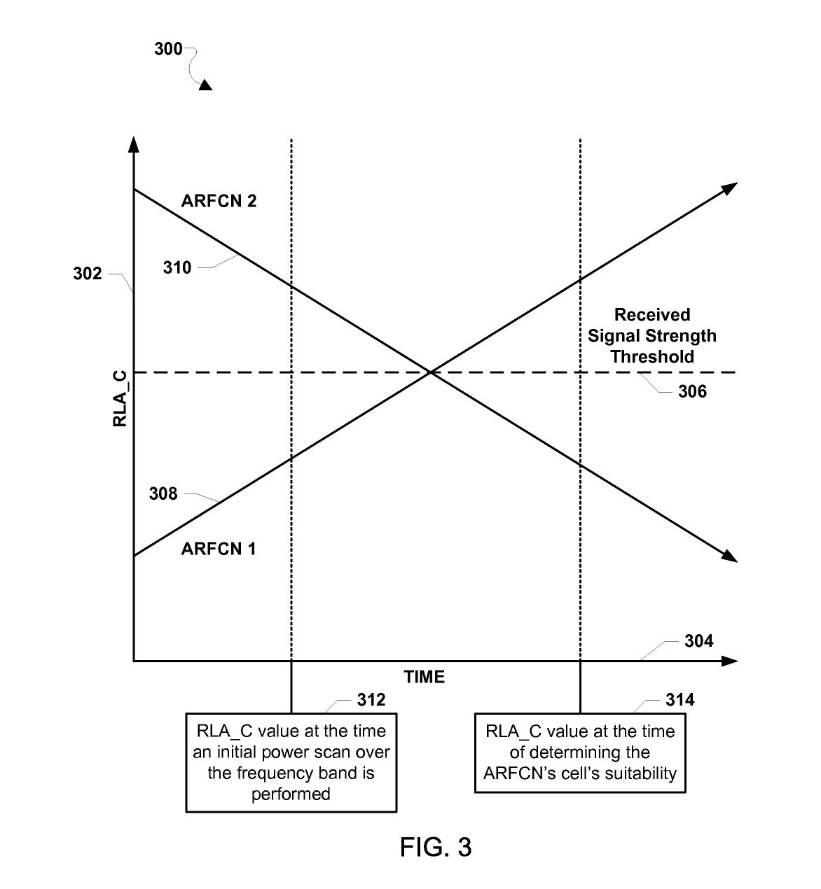

As described above, by using the received signal strength value obtained during the power scan over the frequency band, the mobile communication device may use out-of-date information when calculating the suitability criteria for cells because the ARFCN's received signal strength may have changed during the time elapsed since the power scan over the frequency band. Therefore, the mobile communication device's determination of a suitable cell may be inaccurate, and the mobile communication device may end up camping on a cell that is not suitable or not the most suitable as further described below with reference to FIG. 3.

FIG. 3 illustrates a timeline diagram 300 demonstrating potential changes in ARFCNs' received signal strengths over time. As illustrated in FIG. 3, an ARFCN's received signal strength value (i.e., vertical axis “RLA_C” 302) as measured by a mobile communication device (not shown) may vary over time (i.e., horizontal axis “TIME” 304) for numerous reasons. For example, the RLA_C value for a first ARFCN 308 (i.e., ARFCN 1) may increase over time when the mobile communication device is moving towards the cell associated with the first ARFCN 308, and RLA_C values for a second ARFCN 310 (i.e., ARFCN 2) may decrease over time when the mobile communication device is moving away from the cell associated with the second ARFCN 310. While the changes in the RLA_C values of the ARFCNs 308, 310 are illustrated as changing linearly over time, the RLA_C value may change in a non-linear manner under different circumstances, such as when the mobile communication device is carried into or out of a building, an elevator, etc. Thus, RLA_C values may remain consistent for a period of time followed by a sharp increase or decrease, even an exponential increase or decrease depending on the movements and surroundings of the mobile communication device.

In current implementations of cell selection, the mobile communication device may determine whether an ARFCN's cell is suitable for camping on when the ARFCN has an RLA_C value above a particular received signal strength threshold 306. The mobile communication device may also determine whether an ARFCN's RLA_C value is above the received signal strength threshold 306 during the power scan over the frequency band (i.e., at time 312) and may use that measurement later when calculating the ARFCN's cell's suitability criteria at time 314 (i.e., when determining whether to camp on the ARFCN's cell).

In the example illustrated in FIG. 3, the mobile communication device measures the RLA_C values of the first ARFCN 308 and the second ARFCN 310 during an initial power scan over the frequency band at time 312, but does not determine the cell suitability based on those measurements until a later time 314. This delay between times 312, 314 may be nontrivial as the mobile communication device—and especially multi-SIM communication devices—may have to perform scans of numerous bands using multiple radio access technologies. In this example, the RLA_C values for the ARFCNs change during the time between the initial power scan over the frequency band (i.e., at time 312) and when the mobile communication device uses those RLA_C values to determine the suitability of the ARFCNs' cells (i.e., at time 314). As a result, even though the RLA_C value of the second ARFCN 310 measured at the time 312 exceeded the received signal strength threshold (i.e., indicating that the cell associated with the second ARFCN 310 is a suitable cell), the actual RLA_C value of the second ARFCN 310 when the mobile communication device determines cell suitability at time 314 has decreased below the received signal strength threshold. In this example, the mobile communication device would incorrectly determine that the cell associated with the second ARFCN 310 is suitable when in fact that cell is no longer a suitable cell having a signal strength below the signal strength threshold 306. Similarly, the example in FIG. 3 shows how the mobile communication device would incorrectly determine that the cell associated with the first ARFCN 308 is not suitable when in fact that cell has become a suitable cell, with a signal strength above the signal strength threshold 306, during the time since the power scan over the frequency band was performed (i.e., time 312). Thus, in this example, the mobile communication device may end up camping on the cell associated with the second ARFCN 310 rather than the cell associated with first ARFCN 308's cell because the second ARFCN 310 had a higher RLA_C when the measurements were made at time 312. As a result, the mobile communication device may soon need to perform a cell handover or reselection procedure from the second ARFCN 310's cell to the first ARFCN 308's cell because the first ARFCN 308's cell will be capable of providing better service to the mobile communication device than the second ARFCN 310's cell.

Thus, in current methods of cell selection, the mobile communication device may make inaccurate suitability determinations by using stale RLA_C values, thereby requiring otherwise unnecessary cell hand off operations that require the mobile communication device to expend processing, power, and radio resources.

The scenarios described above may be even more pronounced for a multi-SIM communication device because the multi-SIM communication device may require a comparatively larger amount of time between when RLA_C values are obtained during a power scan over the frequency band and when those values are used to determine cell suitability. Thus, the multi-SIM communication device may use RLA_C values that have changed a considerable amount, making the multi-SIM communication device's cell suitability determinations even more likely to be inaccurate than other mobile communication devices.

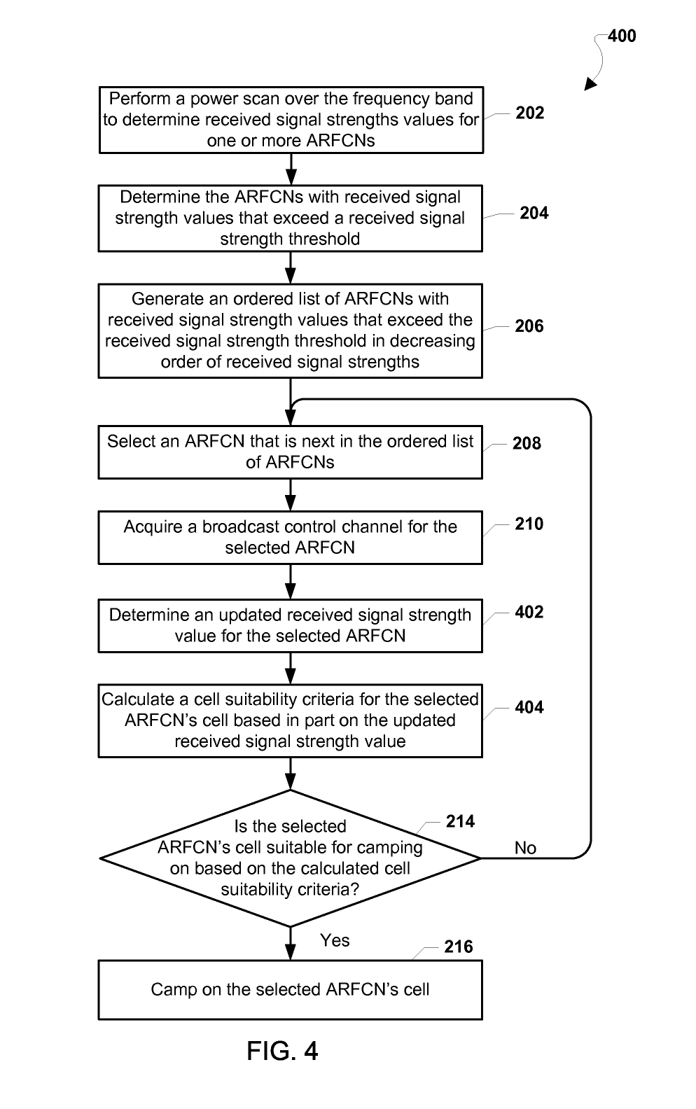

FIG. 4 illustrates an embodiment method 400 that may be implemented by a mobile communication device for selecting a suitable cell to camp on using an updated received signal strength value to overcome the limitations of current processes described above. Implementing the various embodiments, a mobile communication device may improve the accuracy of cell suitability determinations and reduce the number of unnecessary handovers and reselections that may occur by using updated received signal strength measurements for ARFCNs when making cell suitability determinations.

A mobile communication device performing method 400 may perform the conventional operations of performing a power scan over the frequency band in block 202, determining ARFCNs with signal strengths above the threshold in block 204, generating an ordered list of ARFCNs in block 206, selecting an ARFCN from the list in block 208, and acquiring a broadcast control channel signal for the selected ARFCN in block 210 as described above with reference to FIG. 2.

In block 402, the mobile communication device may obtain an updated received signal strength value for the selected ARFCN. In an embodiment, the mobile communication device may measure the received signal strength of the ARFCN in block 402 while acquiring and decoding the ARFCN's BCCH in block 210 of method 200 as described above with reference to FIG. 2. In another embodiment, the mobile communication device may measure the received signal strength of the ARFCN in block 402 after acquiring the broadcast control channel signal for the selected ARFCN.

In block 404, the mobile communication device may calculate cell suitability criteria for the selected ARFCN's cell based in part on the updated signal strength value obtained in block 402.

In determination block 214, the mobile communication device may determine whether the selected ARFCN's cell is suitable for camping on based on the calculated cell suitability criteria. Unlike current methods that use the received signal strength value obtained during the initial power scan over the frequency band, in the various embodiments the mobile communication device may make the cell suitability determination using the most up-to-date information regarding the suitability of the selected ARFCN's cell. By utilizing the updated received signal strength value, the mobile communication device may be able to determine whether the cell associated with the selected ARFCN is a suitable cell with a higher degree of accuracy than contemporary methods because the cell suitability criteria are not impacted by changes in the selected ARFCN's received signal strength since the power scan over the frequency band.

When the mobile communication device determines that the selected ARFCN's cell is suitable for camping on based on the calculated cell suitability criteria (i.e., determination block 214=“Yes”), the mobile communication device may camp on the selected ARFCN's cell in block 216, which may include performing a registration process with the selected ARFCN's cell to enable it to camp on the cell.

When the mobile communication device determines that the selected ARFCN's cell is not suitable for camping on based on the calculated cell suitability criteria (i.e., determination block 214=“No”), the mobile communication device may select another ARFCN that is next in the ordered list of ARFCNs in block 208, and may repeat the processes described above until a suitable cell is selected (i.e., determination block 214=“Yes”).

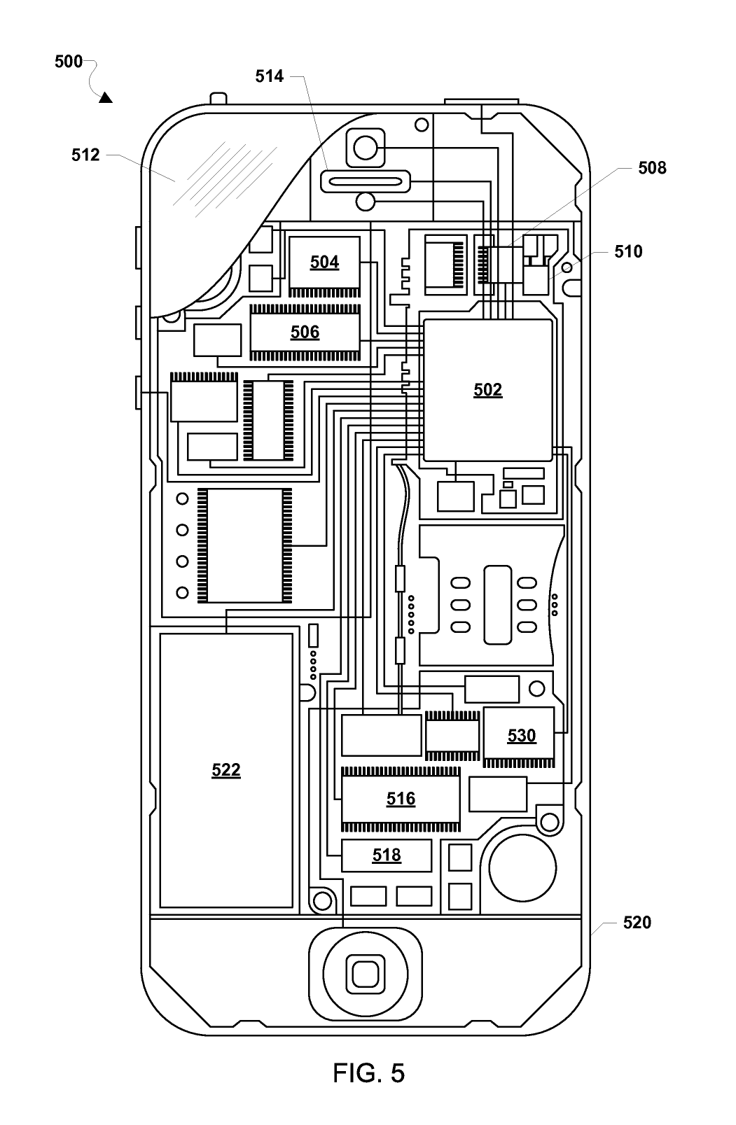

The various embodiments may be implemented in any of a variety of mobile computing devices, an example of which is illustrated in FIG. 5. The mobile computing device 500 may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile computing device 500 need not have touch screen capability.

The mobile computing device 500 may have one or more radio signal transceivers 508 (e.g., Peanut, Bluetooth, Zigbee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile computing device 500 may include a cellular network wireless modem chip 516 that enables communication via a cellular network and is coupled to the processor.

The mobile computing device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile computing device 500 may also include speakers 514 for providing audio outputs. The mobile computing device 500 may also include a housing 520, constructed of a plastic, metal, or a combination of materials, for containing all or some of the components discussed herein. The mobile computing device 500 may include a power source 522 coupled to the processor 502, such as a disposable or rechargeable battery. The rechargeable battery may also be coupled to the peripheral device connection port to receive a charging current from a source external to the mobile computing device 500. The mobile computing device 500 may also include a physical button 524 for receiving user inputs. The mobile computing device 500 may also include a power button 526 for turning the mobile computing device 500 on and off.

The mobile computing device 500 may also include a SIM card 530 that utilizes a cellular telephone transceiver 508 and one or more antennae 510 to connect to a mobile network. While not shown, in further embodiments, the mobile computing device 500 may be a multi-SIM communication device and may include additional SIM cards that utilize one or more cellular telephone transceivers 508 to respectively connect to additional mobile networks.

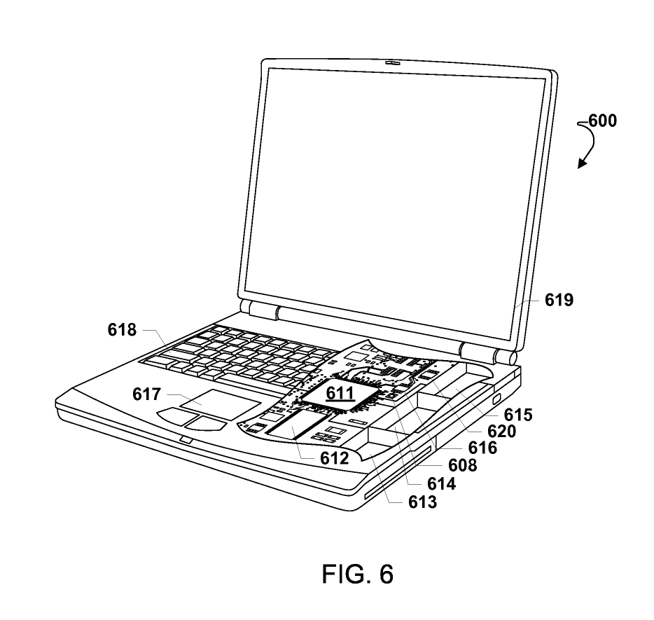

The various embodiments described above may also be implemented within a variety of mobile communication devices, such as a laptop computer 600 illustrated in FIG. 6. Many laptop computers include a touchpad touch surface 617 that serves as the computer's pointing device, and thus may receive drag, scroll, and flick gestures similar to those implemented on mobile computing devices equipped with a touch screen display and described above. A laptop computer 600 may include a processor 611 coupled to volatile memory 612 and a large capacity nonvolatile memory, such as a disk drive 613 of Flash memory. Additionally, the computer 600 may have one or more antenna 608 for sending and receiving electromagnetic radiation that may be connected to a wireless data link and/or cellular telephone transceiver 616 coupled to the processor 611. The computer 600 may also include a floppy disc drive 614 and a compact disc (CD) drive 615 coupled to the processor 611. In a notebook configuration, the computer housing includes the touchpad 617, the keyboard 618, and the display 619 all coupled to the processor 611. Other configurations of the computing device may include a computer mouse or trackball coupled to the processor (e.g., via a USB input) as are well known, which may also be use in conjunction with the various embodiments. The computer 600 may have a SIM card 620 that utilizes a cellular telephone transceiver 616 and one or more antennae 608 to connect to a first and a second mobile network, respectively. While not shown, in further embodiments, the mobile communication device 600 may be a multi-SIM communication device and may include additional SIM cards that utilize one or more cellular telephone transceivers 616 to connect to additional mobile networks.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium (i.e., stored processor-executable software instructions). The steps of a method or algorithm disclosed herein may be embodied in a processor-executable software module and may be performed as processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of determining on a mobile communication device whether to camp on a cell associated with an absolute radio-frequency channel number (“ARFCN”), comprising:
generating an ordered list of ARFCNs with received signal strength values that exceed a received signal strength threshold in decreasing order of received signal strengths;
selecting an ARFCN that is next in the ordered list of ARFCNs;
acquiring a broadcast control channel signal for the selected ARFCN;
determining an updated received signal strength value for the selected ARFCN; and
calculating cell suitability criteria for the selected ARFCN's cell based in part on the updated received signal strength value.

2. The method of claim 1, further comprising:
determining whether the selected ARFCN's cell is suitable for camping on based on the calculated cell suitability criteria;
camping on the selected ARFCN's cell in response to determining that the selected ARFCN's cell is suitable for camping on based on the calculated cell suitability criteria; and
selecting an ARFCN that is next in the ordered list of ARFCNs in response to determining that the selected ARFCN's cell is not suitable for selection.

3. The method of claim 1, wherein determining an updated received signal strength value for the selected ARFCN comprises determining the updated received signal strength value while acquiring the broadcast control channel signal for the selected ARFCN.

4. The method of claim 1, wherein determining an updated received signal strength value for the selected ARFCN comprises determining the updated received signal strength value after acquiring the broadcast control channel signal for the selected ARFCN.

5. The method of claim 1, wherein the mobile communication device is a multi-SIM communication device.

6. A mobile communication device, comprising:
a memory;
a transceiver; and
a processor coupled to the memory and the transceiver, wherein the processor is configured with processor-executable instructions to perform operations comprising:
generating an ordered list of absolute radio-frequency channel numbers (“ARFCNs”) with received signal strength values that exceed a received signal strength threshold in decreasing order of received signal strengths;
selecting an ARFCN that is next in the ordered list of ARFCNs;
acquiring a broadcast control channel signal for the selected ARFCN;
determining an updated received signal strength value for the selected ARFCN; and
calculating cell suitability criteria for the selected ARFCN's cell based in part on the updated received signal strength value.

7. The mobile communication device of claim 6, wherein the processor is configured with processor-executable instructions to perform operations further comprising:
determining whether the selected ARFCN's cell is suitable for camping on based on the calculated cell suitability criteria;
camping on the selected ARFCN's cell in response to determining that the selected ARFCN's cell is suitable for camping on based on the calculated cell suitability criteria; and
selecting an ARFCN that is next in the ordered list of ARFCNs in response to determining that the selected ARFCN's cell is not suitable for selection.

8. The mobile communication device of claim 6, wherein the processor is configured with processor-executable instructions to perform operations such that determining an updated received signal strength value for the selected ARFCN comprises determining the updated received signal strength value while acquiring the broadcast control channel signal for the selected ARFCN.

9. The mobile communication device of claim 6, wherein the processor is configured with processor-executable instructions to perform operations such that determining an updated received signal strength value for the selected ARFCN comprises determining the updated received signal strength value after acquiring the broadcast control channel signal for the selected ARFCN.

10. The mobile communication device of claim 6, further comprising a plurality of Subscriber Identity Modules (SIMs) coupled to the processor.

11. A mobile communication device, comprising:
means for generating an ordered list of absolute radio-frequency channel numbers (“ARFCNs”) with received signal strength values that exceed a received signal strength threshold in decreasing order of received signal strengths;
means for selecting an ARFCN that is next in the ordered list of ARFCNs;
means for acquiring a broadcast control channel signal for the selected ARFCN;
means for determining an updated received signal strength value for the selected ARFCN; and
means for calculating cell suitability criteria for the selected ARFCN's cell based in part on the updated received signal strength value.

12. The mobile communication device of claim 11, further comprising:
means for determining whether the selected ARFCN's cell is suitable for camping on based on the calculated cell suitability criteria;
means for camping on the selected ARFCN's cell in response to determining that the selected ARFCN's cell is suitable for camping on based on the calculated cell suitability criteria; and
means for selecting an ARFCN that is next in the ordered list of ARFCNs in response to determining that the selected ARFCN's cell is not suitable for selection.

13. The mobile communication device of claim 11, wherein means for determining an updated received signal strength value for the selected ARFCN comprises means for determining the updated received signal strength value while acquiring the broadcast control channel signal for the selected ARFCN.

14. The mobile communication device of claim 11, wherein means for determining an updated received signal strength value for the selected ARFCN comprises means for determining the updated received signal strength value after acquiring the broadcast control channel signal for the selected ARFCN.

15. The mobile communication device of claim 11, wherein the mobile communication device is a multi-SIM communication device.

16. A non-transitory processor-readable storage medium having stored thereon processor-executable software instructions configured to cause a processor of a mobile communication device to perform operations comprising:
generating an ordered list of absolute radio-frequency channel numbers (“ARFCNs”) with received signal strength values that exceed a received signal strength threshold in decreasing order of received signal strengths;
selecting an ARFCN that is next in the ordered list of ARFCNs;
acquiring a broadcast control channel signal for the selected ARFCN;
determining an updated received signal strength value for the selected ARFCN; and
calculating cell suitability criteria for the selected ARFCN's cell based in part on the updated received signal strength value.

17. The non-transitory processor-readable storage medium of claim 16, wherein the stored processor-executable software instructions are configured to cause a processor of a mobile communication device to perform operations further comprising:
determining whether the selected ARFCN's cell is suitable for camping on based on the calculated cell suitability criteria;
camping on the selected ARFCN's cell in response to determining that the selected ARFCN's cell is suitable for camping on based on the calculated cell suitability criteria; and
selecting an ARFCN that is next in the ordered list of ARFCNs in response to determining that the selected ARFCN's cell is not suitable for selection.

18. The non-transitory processor-readable storage medium of claim 16, wherein the stored processor-executable software instructions are configured to cause a processor of a mobile communication device to perform operations such that determining an updated received signal strength value for the selected ARFCN comprises determining the updated received signal strength value while acquiring the broadcast control channel signal for the selected ARFCN.

19. The non-transitory processor-readable storage medium of claim 16, wherein the stored processor-executable software instructions are configured to cause a processor of a mobile communication device to perform operations such that determining an updated received signal strength value for the selected ARFCN comprises determining the updated received signal strength value after acquiring the broadcast control channel signal for the selected ARFCN.

20. The non-transitory processor-readable storage medium of claim 16, wherein the mobile communication device is a multi-SIM communication device.
